(19) United States
(12) Patent Application Publication
(10) Pub. No.: US 2008/0081734 A1
(43) Pub. Date: Apr. 3, 2008

(54) Power system

(75) Inventors: Kevin Patrick Duffy, Metamora, IL (US); David Andrew Pierpont, Dunlap, IL (US); Charles E. Rose, Metamora, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/529,482

(22) Filed: Sep. 29, 2006

(51) Int. Cl. B60W 10/04

(52) U.S. Cl. 477/107

(57) ABSTRACT

A method of operating a power system of a machine is provided. The method may include selectively supplying power from an engine to one or more other components of the machine., including, during at least some load increases on the power system, supplementing power from the engine with power from an additional power source. The method may also include, during at least some load increases on the power system, supplementing power from the engine with power from an additional power source while recirculating exhaust gas through the engine.

### TECHNICAL FIELD

The present disclosure relates to power systems for machines and, more particularly, to power systems that include an engine.

### BACKGROUND

Many machines have a power system with an engine that provides power to perform various tasks. While the engine of such a power system is producing power, the engine produces exhaust gas, which often includes various undesirable emissions, such as NOₓ. The engine of such a power system may produce greater quantities of emissions when load increases on the power system put the engine under high load and/or when the engine accelerates rapidly than when the engine operates under light load/steady-state conditions.

U.S. Pat. No. 5,203,311 to Hitomi et al. (“the '311 patent”) shows an engine with an exhaust-gas-recirculation (EGR) system and a method of reducing NOₓ, emissions from the engine by recirculating exhaust gas through the engine with the EGR system. The EGR system shown by the '311 patent includes a first duct with a first valve connected between an exhaust system of the engine and an intake passage of the engine. The EGR system shown by the '311 patent also includes a second duct with a second valve and a cooler connected between the exhaust system and the intake passage. The '311 patent discloses opening the first valve and closing the second valve to recirculate exhaust gas exclusively through the first duct when the engine is under light load. Conversely, the '311 patent discloses opening the second valve and closing the first valve to recirculate exhaust gas exclusively through the second duct when the engine is under full load.

Although the '311 patent discloses recirculating exhaust gas through the engine to reduce NOₓ emissions, certain disadvantages persist. For example, placing high loads on the engine while recirculating exhaust gas through the engine may significantly compromise performance. Recirculating exhaust gas through the engine may impact the amount of power the engine can produce. As a result, recirculating exhaust gas through the engine with a high load on the engine may impact the ability of the engine to meet the load. Additionally, recirculating exhaust gas through the engine with a high load on the engine may cause the engine to produce undesirably high amounts of hydrocarbon particulate emissions.

The power system and methods of the present disclosure solve one or more of the problems set forth above.

### SUMMARY OF THE INVENTION

One disclosed embodiment relates to a method of operating a power system of a machine. The method may include selectively supplying power from an engine to one or more other components of the machine. The method may also include, during at least some load increases on the power system, supplementing power from the engine with power from an additional power source while recirculating exhaust gas through the engine.

Another embodiment relates to a power system for a machine. The power system may include an engine, an additional power source, and power-system controls. The power-system controls may be operable to selectively cause the power system to supply power from the engine to one or more other components of the machine. The power-system controls may also be operable to, during at least some load increases on the power system, supplement power from the engine with power from the additional power source while recirculating exhaust gas through the engine.

A further embodiment relates to a method of operating a power system of a machine. The method may include selectively propelling the machine at least in part by supplying power from an engine to a propulsion device, including, when accelerating the machine, adjusting a speed ratio between the engine and the propulsion device as necessary to accelerate the machine at a target rate while maintaining acceleration of the engine within a target range.

### BRIEF DESCRIPTION OF THE DRAWINGS

FIG. 1 is a diagrammatic illustration of one embodiment of a machine that includes a power system according to the present disclosure; and

FIG. 2 is a flow chart showing one method of operating a power system according to the present disclosure.

### DETAILED DESCRIPTION

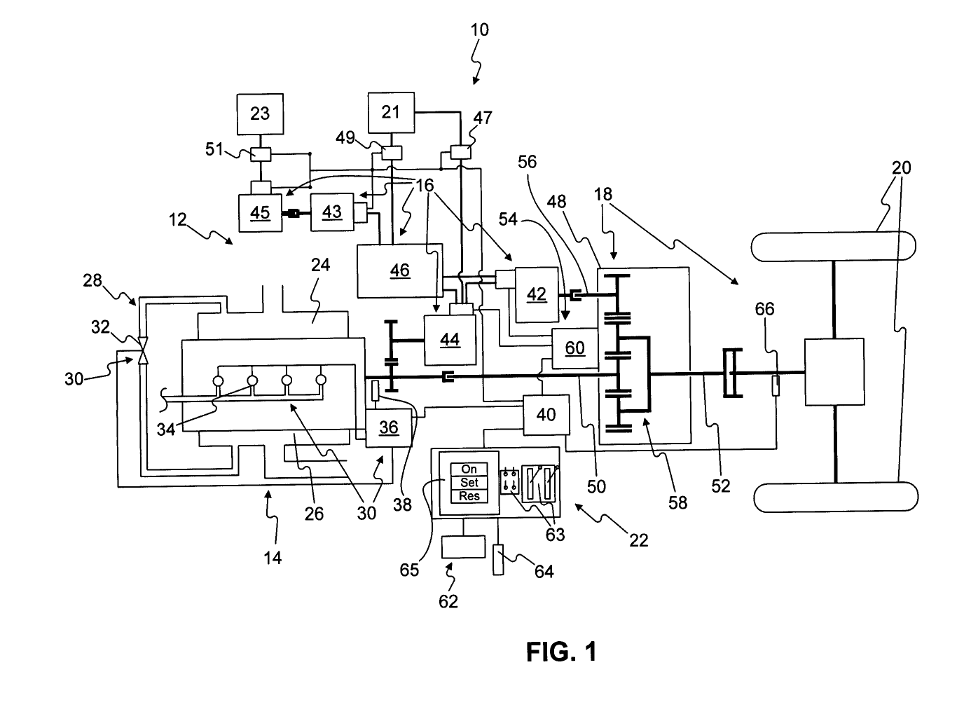

FIG. 1 illustrates a machine 10 having a power system 12 according to the present disclosure. Power system 12 may include an engine 14, additional power sources 16, a drive train 18, propulsion devices 20, power-system controls 22, power-consuming devices 21, and power-consuming devices 23.

Engine 14 may be any type of device operable to produce power by combusting fuel. For example, engine 14 may be a diesel engine, a gasoline engine, a gaseous-fuel-driven engine, or a gas turbine engine. Engine 14 may include combustion chamber(s) (not shown), an intake system 24, an exhaust system 26, an exhaust-gas-recirculation (EGR) system 28, and engine controls 30. Intake system 24 may include any components for delivering charge gas to the combustion chamber(s) of engine 14, and exhaust system 26 may include any components for directing exhaust gas from the combustion chamber(s) of engine 14. EGR system 28 may include any components operable to direct exhaust gas into intake system 24 to thereby recirculate that exhaust gas through engine 14. For example, as FIG. 1 shows, EGR system 28 may include one or more passages connected between exhaust system 26 and intake system 24 for directing exhaust gas from exhaust system 26 to intake system 24. EGR system 28 may also include an exhaust-gas-recirculation (EGR) valve 32 for controlling whether and/or at what rate exhaust gas recirculates through engine 14.

Engine controls 30 may include any components operable to control one or more aspects of the operation of engine 14. In some embodiments, engine controls 30 may include EGR valve 32, a fuel-metering system 34, and an engine controller 36. Fuel-metering system 34 may include any components operable to control how much fuel engine 14 combusts per unit time. Engine controller 36 may be any type of information-processing device. Engine controller 36 may be operatively connected to EGR valve 32 and fuel-metering system 34 so that engine controller 36 may control how much exhaust gas EGR valve 32 allows to recirculate through engine 14 and how fuel-metering system 34 delivers fuel to engine 14. Engine controller 36 may also be operatively connected to various other control components, such as other actuators, valves, sensors, and/or controllers. For example, an engine-speed sensor 38 may provide engine controller 36 a signal indicating the operating speed of engine 14. Additionally, engine controller 36 may communicate with a master controller 40 of power system 12.

Additional power sources 16 may include various types of components operable to supply power to one or more components of power system 12. In some embodiments, additional power sources 16 may include a motor 42, a motor 43, and a power-conversion unit 44. Each motor 42, 43 may be an electric motor or a fluid-powered motor, such as a hydraulic or pneumatic motor. Power-conversion unit 44 may be any type of device operable to convert mechanical power into another form of power that motors 42, 43 can use to produce mechanical power. For example, in embodiments where motors 42, 43 are electric motors, power-conversion unit 44 may be an electric generator. Similarly, in embodiments where motors 42, 43 are fluid-powered motors, power-conversion unit 44 may be a fluid pump. Power-conversion unit 44 may be drivingly connected to engine 14 so that power-conversion unit 44 may convert mechanical power from engine 14 into a form that motor 42 can use.

Additional power sources 16 may also include an energy-storage device 46 connected to motors 42, 43. Energy-storage device 46 may be any type of device configured to store energy and supply power to motors 42, 43 in a form that motors 42, 43 can use to produce mechanical power. For example, in embodiments where motors 42, 43 are electric motors, energy-storage device 46 may be an electrical storage device, such as a capacitor or a battery. Similarly, in embodiments where motors 42, 43 are fluid-powered motors, energy-storage device 46 may be a fluid reservoir. Various other power sources may supply the energy stored by energy-storage device 46. In some embodiments, power-conversion unit 44 may be connected to energy-storage device 46 so that power-conversion unit 44 may supply power to energy-storage device 46.

Additional power sources 16 may also include a power-conversion unit 45. Power-conversion unit 45 may be drivingly connected to motor 43. Power-conversion unit 45 may be any type of device operable to receive mechanical power from motor 43 and convert at least a portion of that power into another form. For example, power-conversion unit 45 may be an electric generator or a fluid pump. In some embodiments, power-conversion unit 45 may be configured to convert mechanical power into a different form of power than the form of power that energy-storage device 46 receives and supplies. For example, energy-storage device 46 may be a fluid reservoir that receives and supplies pressurized fluid, and power-conversion unit 45 may be an electric generator. Conversely, energy-storage device 46 may be an electrical storage device that receives and supplies electricity, and power-conversion unit 45 may be a fluid pump.

Additional power sources 16 are not limited to those shown in FIG. 1 and discussed above. Additional power sources 16 may include other devices operable to supply power to motors 42, 43 and power-consuming devices 21, 23. For example, in some embodiments, additional power sources 16 may include a fuel cell operable to supply electricity to motors 42, 43 and power-consuming devices 21, 23. Similarly, additional power sources 16 may include an additional engine and power-conversion unit for supplying power to motors 42, 43 and power-consuming devices 21, 23. Furthermore, additional power sources 16 may include devices other than motor 42 for mechanically supplying power to drive train 18. Moreover, additional power sources 16 may omit one or more of motor 42, motor 43, power-conversion unit 44, power-conversion unit 45, and energy-storage device 46.

Drive train 18 may include a multiple-ratio transmission 48 and various other components for transmitting power from engine 14 to propulsion devices 20. Multiple-ratio transmission 48 may include a rotary input member 50 drivingly connected to engine 14, a rotary output member 52 drivingly connected to propulsion devices 20, provisions for transferring power between rotary input member 50 and rotary output member 52, and transmission controls 54. Multiple-ratio transmission 48 may have any configuration enabling multiple-ratio transmission 48 to transfer power between rotary input member 50 and rotary output member 52 at any of a plurality of speed ratios under the control of transmission controls 54.

In some embodiments, the configuration of multiple-ratio transmission 48 may allow adjusting the speed ratio between rotary input member 50 and rotary output member 52 through a continuous range. FIG. 1 shows such an embodiment. As FIG. 1 shows, multiple-ratio transmission 48 may include an additional rotary input member 56. Multiple-ratio transmission 48 may also include a planetary gear set 58 connected to rotary input members 50, 56 and rotary output member 52 in a manner such that the speed ratio between rotary input member 50 and rotary output member 52 varies continuously as a function of the speed of rotary input member 56. Rotary input member 56 may be drivingly connected to motor 42. As a result, the speed ratio between rotary input member 50 and rotary output member 52 may vary continuously as a function of the speed of motor 42.

Transmission controls 54 may include any components operable to control whether and/or at what speed ratio multiple-ratio transmission 48 transfers power between rotary input member 50 and rotary output member 52. In some embodiments, transmission controls 54 may include a transmission controller 60, which may be any type of information-processing device. Transmission controller 60 may be operatively connected to motor 42 and power-conversion unit 44 so that transmission controller 60 can control the speed ratio between rotary input member 50 and rotary output member 52 by controlling the speed of motor 42. Additionally, transmission controls 54 may include various other control components, such as actuators, sensors, and/or valves, some or all of which may be operatively connected to transmission controller 60.

Multiple-ratio transmission 48 is not limited to the configuration shown in FIG. 1. For example, multiple-ratio transmission 48 may include other provisions in addition to, or in place of, planetary gear set 58 for transmitting power between rotary input member 50 and rotary output member 52. In some embodiments, the configuration of multiple-ratio transmission 48 may provide only a finite set of discrete speed ratios at which multiple-ratio transmission 48 may transmit power between rotary input member 50 and rotary output member 52. Additionally, in some embodiments, multiple-ratio transmission 48 may omit rotary input member 56.

Propulsion devices 20 may be any type of device operable to apply power to the environment surrounding machine 10 in a manner to propel machine 10. For example, as FIG. 1 shows, propulsion devices 20 may be wheels. Alternatively, propulsion devices 20 may be track units or other types of devices configured to apply power to the ground to propel machine 10. In some embodiments, propulsion devices 20 may be propellers or other types of devices configured to propel machine 10 using fluid.

Power-consuming devices 21, 23 may include any types of components that use power from other components of power system 12 to perform one or more tasks. Power-consuming devices 21 and/or power-consuming devices 23 may include one or more hydraulically and/or electrically powered implements, including, but not limited to, excavating implements, hoists, winches, compactors, clamps, hammers, brooms, saws, chippers, grinders, and/or similar devices. In some embodiments, power-consuming devices 21 may use a different form of power than power-consuming devices 23. For example, power-consuming devices 21 may use electricity, and power-consuming devices 23 may use hydraulic power. Conversely, power-consuming devices 21 may use hydraulic power, and power-consuming devices 23 may use electricity.

Power-consuming devices 21 may connect to power-conversion unit 44 and energy-storage device 46. Power-control components 47 may control the amount of power supplied from power-conversion unit 44 to power-consuming devices 21, and power-control components 49 may control the amount of power supplied from energy-storage device 46 to power-consuming devices 23. Power-control components 47 and power-control components 49 may include any types of components operable to control the flow of power from one device to another, such as valves and/or electrical power-regulation devices.

Power-consuming devices 23 may connect to power-conversion unit 45 so that power-consuming devices 23 may receive power from power-conversion unit 45, which power may come from energy-storage device 46 and motor 43. Power-control components 51 may control the amount of power supplied from power-conversion unit 45 to power-consuming devices 23. Power-control components 51 may include any types of components operable to control the flow of power from one device to another, such as valves and/or electrical power-regulation devices.

Power-system controls 22 may include any components operable to control power system 12 in the manners discussed hereinbelow. In some embodiments, power-system controls 22 may include engine controls 30, transmission controls 54, an operator interface 62, and master controller 40. Operator interface 62 may include various components configured to transmit operator inputs to other components of machine 10. For example, operator interface 62 may include a throttle 64 and various associated components for communicating operator inputs relating to desired speed and/or acceleration of machine 10 to other components. Additionally, operator interface 62 may include a cruise-control system 65 operable to communicate to other components of machine 10 an operator-determined target travel speed for machine 10. Furthermore, operator interface 62 may include various other operator input devices 63 operable to transmit operator inputs relating to desired operation of various power-consuming devices 21, 23.

Master controller 40 may be any type of information-processing device. Master controller 40 may be operatively connected to engine controls 30, transmission controls 54, motor 43, power-conversion unit 44, power-conversion unit 45, and operator interface 62. Additionally, master controller 40 may be operatively connected to power-control components 47, 49, 51 and/or to some or all of power-consuming devices 21, 23 so that master controller 40 may monitor and control power flow from power-conversion units 44, 45 and energy-storage device 46 to power-consuming devices 21, 23. Furthermore, master controller 40 may be operatively connected to various additional sources of information about operating conditions of machine 10. For example, master controller 40 may be operatively connected to a travel-speed sensor 66 that provides master controller 40 with a signal indicating the travel speed of machine 10. Master controller 40 may also be operatively connected to various other sources of information, such as other sensors (not shown) and/or other controllers. Accordingly, master controller 40 may coordinate control of the various systems of machine 10 dependent on inputs from engine controls 30, transmission controls 54, operator interface 62, and other sources of information.

Power system 12 is not limited to the configuration shown in FIG. 1. For example, drive train 18 may connect engine 14, multiple-ratio transmission 48, and propulsion devices 20 in different manners than FIG. 1 shows. Additionally, in some embodiments, power system 12 may omit drive train 18 and propulsion devices 20. Furthermore, power-system controls 22 may have a different configuration than shown in FIG. 1. In some embodiments, one controller may replace two or more of engine controller 36, master controller 40, and transmission controller 60.

### Industrial Applicability

Power system 12 may have application in any machine that requires power to perform one or more tasks. Power system 12 may provide power to propel machine 10 by supplying power from engine 14 and/or motor 42, through multiple-ratio transmission 48, to propulsion devices 20. Additionally, power system 12 may provide power for performing various other tasks with power-consuming devices 21, 23 by supplying power from engine 14 to power-consuming devices 21, 23. Power system 12 may supply power from engine 14 to power-consuming devices 21, 23 through one or more path(s) that include some combination of one or more of power-conversion unit 44, power-conversion unit 45, motor 43, and energy-storage device 46.

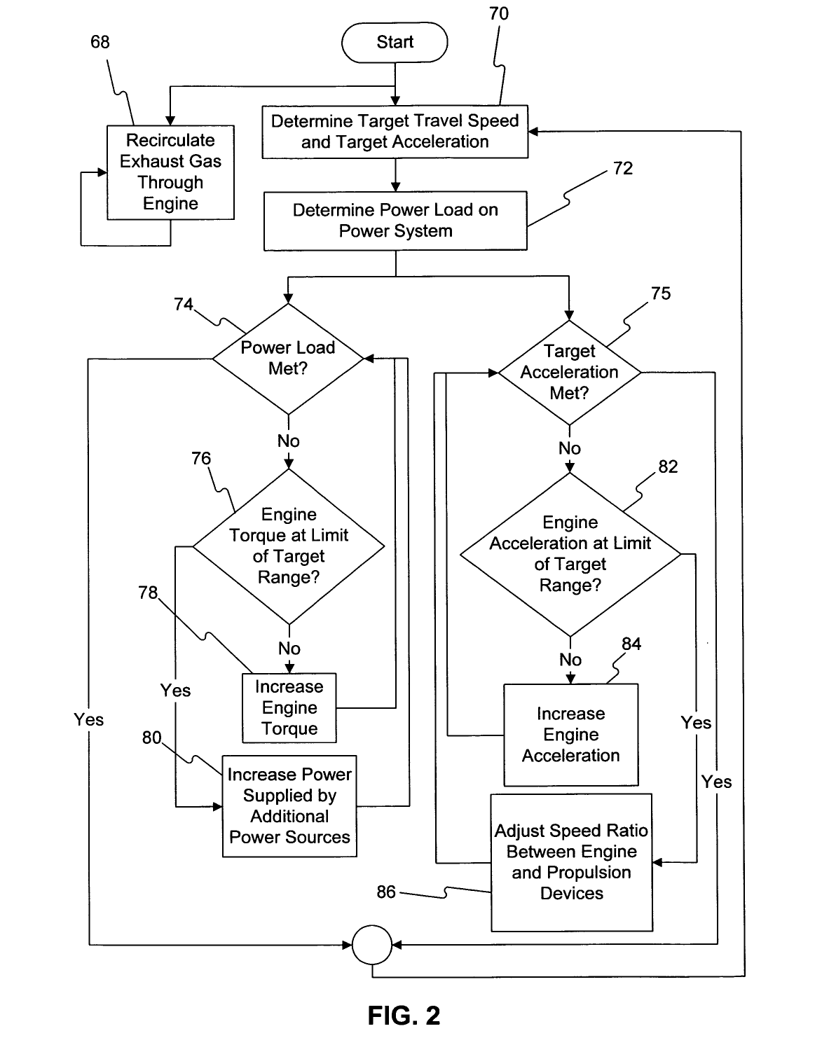

When power system 12 is supplying power from engine 14 to one or more other components of machine 10, power-system controls 22 may coordinate operation of engine 14, additional power sources 16, and drive train 18 in various ways to meet the power needs of machine 10. FIG. 2 illustrates one control method that power-system controls 22 may implement to maintain desirable performance of power system 12 in a variety of circumstances. Principally, the method illustrated in FIG. 2 involves continuously recirculating exhaust gas through engine 14 (step 68) and using multiple-ratio transmission 48 and additional power sources 16 to buffer increases in speed and load on engine 14. Power-system controls 22 may continuously recirculate exhaust gas through engine 14 by holding EGR valve 32 at least partially open so that exhaust gas may flow from exhaust system 26, through EGR system 28, to intake system 24 and, from there, back through engine 14.

At the same time, power-system controls 22 may make various determinations relating to the power needs of machine 10. Initially, power-system controls 22 may determine a target travel speed and target acceleration rate for machine 10 (step 70). Power-system controls 22 may determine the target travel speed and target acceleration rate based on various factors, such as inputs from throttle 64, cruise-control system 65, and travel-speed sensor 66. In some circumstances, inputs to power-system controls 22 may indicate no need to propel machine 10, which may cause a target travel speed of zero and a target acceleration rate of zero.

After determining the target travel speed and target acceleration rate, power-system controls 22 may determine the power load on power system 12 (step 72). The power load on power-system 12 may include the power required to propel machine 10 at the target travel speed and acceleration rate and the power required by power-consuming devices 21, 23.

After determining the target acceleration rate and the power load on power system 12, power-system controls 22 may determine whether power system 12 is meeting the power load (step 74) and the target acceleration (step 75). Under steady-state conditions, power-system controls 22 will find that power system 12 is meeting the power load and the target acceleration. Accordingly, in such circumstances, power-system controls 22 may repeatedly reevaluate the target travel speed, target acceleration, and power load (steps 70, 72).

When the power load increases, power-system controls 22 may find that power system 12 is not meeting the power load (step 74). If so, power-system controls 22 may increase the power supplied to the components of machine 10 to meet the increased power load. Power-system controls 22 may increase the power supplied to the components of machine 10 by increasing the amount of power engine 14 supplies. Alternatively, using additional power sources 16, power-system controls 22 may increase the power supplied to the components of machine 10 without increasing the power engine 14 supplies. In order to determine which of these approaches to take, power-system controls 22 may determine whether the torque output of engine 14 is at the limit of a target engine-torque range (step 76). The target engine-torque range for engine 14 may be a subset of the full range of torque output that engine 14 can provide. The target engine-torque range may be defined as a fixed numerical range, or it may be defined as a function of one or more operating conditions of machine 10, such as engine speed, engine temperature, ambient air temperature, and/or various other factors.

If power system 12 is not meeting the power load (step 74) and the torque output of engine 14 is not at the limit of the target engine-torque range for engine 14, power-system controls 22 may first attempt to meet the power load by increasing the torque output of engine 14 (step 78). Power-system controls 22 may do so by adjusting various aspects of the operation of engine 14, including the rate at which fuel-metering system 34 delivers fuel. Power-system controls 22 may continue increasing the torque output of engine 14 until the power load is met or the torque output of the engine 14 reaches the limit of the target engine-torque range.

If the torque output of engine 14 reaches the limit of the target engine-torque range (step 76) and the power load is not met, power-system controls 22 may supplement power from engine 14 by increasing the amount of power supplied to the components of machine 10 by additional power sources 16 (step 80). For example, by increasing the power output of motor 42 with power drawn from energy-storage device 46 or another power source that does not derive its power from engine 14, power-system controls 22 may increase the power provided to propulsion devices 20 without increasing the power that engine 14 supplies. Similarly, by increasing the net power supplied by energy-storage device 46 and/or supplying power from another power-source that does not derive power from engine 14, power-system controls 22 may increase the power supplied to power-consuming devices 21, 23 without increasing the power supplied by engine 14. Power-system controls 22 may continue increasing the amount of supplemental power supplied to the components of machine 10 from additional power sources 16 until the power load is met (step 74).

If power-system controls 22 determine that power system 12 is not meeting the target acceleration for machine 10 (step 75), power-system controls 22 may take steps to increase acceleration of machine 10. Power-system controls 22 may increase the acceleration of machine 10 by increasing acceleration of engine 14 and/or by increasing the speed ratio between engine 14 and propulsion devices 20. In order to determine whether to increase acceleration of engine 14, power-system controls 22 may determine whether acceleration of engine 14 is at the limit of a target engine-acceleration range (step 82). Power-system controls 22 may determine the actual engine acceleration using signals from engine-speed sensor 38. The target engine-acceleration range may include rates at which engine 14 can accelerate without producing undesirable levels of emissions. The target engine-acceleration range may be defined as a fixed, numerical range, or it may be defined in terms of one or more operating conditions of machine 10, such as torque output, engine speed, engine temperature, ambient air temperature, and/or various other factors.

If power system 12 is not meeting the target acceleration (step 75) and the acceleration of engine 14 is not at the limit of the target engine-acceleration range, power-system controls 22 may increase the acceleration of engine 14 (step 84). Power-system controls 22 may increase the acceleration of engine 14 by adjusting various aspects of the operation of engine 14, such as the fuel delivery by fuel-metering system 34. Power-system controls 22 may continue increasing the acceleration of engine 14 until the target acceleration is met (step 75) or the engine acceleration reaches the limit of the target engine-acceleration range.

If engine acceleration reaches the limit of the target engine-acceleration range (step 82) without meeting the target acceleration for machine 10 (step 75), power-system controls 22 may increase the acceleration of machine 10 by adjusting the speed ratio between engine 14 and propulsion devices 20 (step 86). In some embodiments, power-system controls 22 may do so by adjusting the speed ratio between rotary input member 50 and rotary output member 52 of multiple-ratio transmission 48 through a continuous range. For example, power-system controls 22 may adjust the speed of motor 42 to adjust the speed ratio between rotary input member 50 and rotary output member 52. Power-system controls 22 may supply any additional power needed to change the speed of motor 42 from power-conversion unit 44 and/or energy-storage device 46, depending on whether engine 14 can supply additional power to power-conversion unit 44 without exceeding the target engine-torque range for engine 14.

Methods according to which power-system controls 22 may operate power system 12 are not limited to the examples discussed above in connection with FIG. 2. For example, power-system controls 22 may implement different processes for determining whether and to what extent to buffer engine-load and engine-speed increases during load increases on power system 12 and acceleration of machine 10. In some embodiments, power-system controls 22 may buffer all engine-load and engine-speed increases, rather than only those that exceed target engine torque and engine speed ranges. Additionally, power-system controls 22 may omit one or more of the actions shown in FIG. 2. In some embodiments, power-system controls 22 may buffer engine-load increases, but not engine-speed increases. Conversely, in some embodiments, power-system controls 22 may buffer engine-speed increases, but not engine-load increases.

The disclosed embodiments may provide a number of performance advantages. The disclosed methods may provide strong response to transient changes in the power needs of machine 10 without imposing large transient loads on engine 14 or accelerating engine 14 at undesirably high rates. Recirculating exhaust gas through engine 14 while buffering engine-load and engine-speed increases may help suppress both NOₓ and hydrocarbon particulate emissions during load increases on power system 12 and acceleration of machine 10. Reducing NOₓ and hydrocarbon particulate emissions during load increases and acceleration may create leeway to improve various other aspects of the performance of power-system 12, such as fuel efficiency.

Additionally, buffering engine-load and engine-speed increases with additional power sources 16 and multiple-ratio transmission 48 may reduce the size of engine 14 required to meet the power needs of machine 10. This may allow downsizing engine 14, which may decrease the component cost associated with engine 14, reduce the weight of machine 10, and make it easier to fit engine 14 within the space available on machine 10. Additionally, downsizing engine 14 may allow downsizing various components associated with engine 14. For example, it may allow downsizing various cooling system components associated with engine 14 because downsizing engine 14 may reduce the amount of heat produced by engine 14. Downsizing various components associated with engine 14 may further decrease component costs associated with machine 10, further reduce the weight of machine 10, and make it easier to fit the various components of machine 10 within the space available on machine 10.

It will be apparent to those skilled in the art that various modifications and variations can be made in the power system and methods without departing from the scope of the disclosure. Other embodiments of the disclosed power system and methods will be apparent to those skilled in the art from consideration of the specification and practice of the power system and methods disclosed herein. It is intended that the specification and examples be considered as exemplary only, with a true scope of the disclosure being indicated by the following claims and their equivalents.

What is claimed is:

1. A method of operating a power system of a machine, comprising:
selectively supplying power from an engine to one or more other components of the machine; and
during at least some load increases on the power system, supplementing power from the engine with power from an additional power source while recirculating exhaust gas through the engine.

2. The method of claim 1, wherein supplementing power from the engine with power from the additional power source during at least some load increases on the power system includes supplementing power from the engine as necessary to meet power needs of the machine while maintaining torque output of the engine within a target torque range.

3. The method of claim 2, wherein selectively supplying power from the engine to one or more other components of the machine includes selectively propelling the machine at least in part by supplying power from the engine to a propulsion device, including, when accelerating the machine, adjusting a speed ratio between the engine and the propulsion device as necessary to accelerate the machine at a target rate while maintaining acceleration of the engine within a target range.

4. The method of claim 1, wherein selectively supplying power from the engine to one or more other components of the machine includes selectively propelling the machine at least in part by supplying power from the engine to a propulsion device, including, when accelerating the machine, adjusting a speed ratio between the engine and the propulsion device as necessary to accelerate the machine at a target rate while maintaining acceleration of the engine within a target range.

5. The method of claim 4, wherein adjusting the speed ratio between the engine and the propulsion device as necessary to accelerate the machine at a target rate while maintaining acceleration of the engine within a target range includes adjusting the speed ratio through a continuous range.

6. The method of claim 4, wherein adjusting the speed ratio between the engine and the propulsion device as necessary to accelerate the machine at a target rate while maintaining acceleration of the engine within a target range includes adjusting the speed ratio of a multiple-ratio transmission through a continuous range by adjusting the speed of a motor drivingly connected to one or more components of the multiple-ratio transmission.

7. The method of claim 1, wherein supplementing power from the engine with power from the additional power source includes supplying power from an electric motor to a propulsion device.

8. A power system for a machine, comprising:
an engine;
an additional power source;
power-system controls operable to
selectively cause the power system to supply power from the engine to one or more other components of the mobile machine, and
during at least some load increases on the power system, supplement power from the engine with power from the additional power sourcewhile recirculating exhaust gas through the engine.

9. The power system of claim 8, wherein the additional power source includes an electric motor.

10. The power system of claim 8, wherein the additional power source includes a hydraulic motor.

11. The power system of claim 8, wherein selectively causing the power system to supply power from the engine to one or more other components of the machine includes selectively propelling the machine at least in part by supplying power from the engine to a propulsion device, including when accelerating the machine, adjusting a speed ratio between the engine and the propulsion device as necessary to accelerate the machine at a target rate while maintaining acceleration of the engine within a target range.

12. The power system of claim 11, wherein supplementing power from the engine with power from the additional power source during at least some load increases on the power system includes supplementing power from the engine as necessary to meet power needs of the machine while maintaining torque output of the engine within a target range.

13. The power system of claim 11, further including:
a multiple-ratio transmission; and
wherein adjusting the speed ratio between the engine and the propulsion device as necessary to accelerate the machine at a target rate while maintaining acceleration of the engine within a target range includes adjusting a speed ratio of the multiple-ratio transmission through a continuous range.

14. The power system of claim 11, further including:
a multiple-ratio transmission;
wherein the additional power source includes a motor drivingly connected to one or more components of the multiple-ratio transmission; and
wherein adjusting the speed ratio between the engine and the propulsion device as necessary to accelerate the machine at a target rate while maintaining acceleration of the engine within a target range includes adjusting the speed ratio of the multiple-ratio transmission through a continuous range by adjusting the speed of the motor.

15. The power system of claim 8, wherein supplementing power from the engine with power from the additional power source during at least some load increases on the power system includes supplementing power from the engine as necessary to meet power needs of the machine while maintaining torque output of the engine within a target torque range.

16. A method of operating a power system of a machine, comprising:
selectively propelling the machine at least in part by supplying power from an engine to a propulsion device, including, when accelerating the machine, adjusting a speed ratio between the engine and the propulsion device as necessary to accelerate the machine at a target rate while maintaining acceleration of the engine within a target range.

17. The method of claim 16, wherein adjusting the speed ratio between the engine and the propulsion device includes adjusting the speed ratio through a continuous range.

18. The method of claim 17, wherein adjusting the speed ratio between the engine and the propulsion device includes adjusting a speed ratio of a multiple-ratio transmission through a continuous range by adjusting the speed of a motor drivingly connected to one or more components of the multiple-ratio transmission.

19. The method of claim 16, further including, when accelerating the machine, recirculating exhaust gas through the engine.

20. The method of claim 16, wherein selectively propelling the machine at least in part by supplying power from the engine to the propulsion device includes supplementing power from the engine with power from an additional power source as necessary to meet propulsion needs of the machine while maintaining torque output of the engine within a target range.
